(19) United States
(12) Patent Application Publication
(10) Pub. No.: US 2024/0248693 A1
(43) Pub. Date: Jul. 25, 2024

(54) CURATED EXPERIENCE FRAMEWORK FOR SOFTWARE INSTALLATION CONFIGURATION

(71) Applicant: Salesforce, Inc., San Francisco, CA (US)

(72) Inventors: Billy Ma, San Francisco, CA (US); Pranit Shah, San Francisco, CA (US); Gang Shu, San Francisco, CA (US); Tia Williams, Atlanta, GA (US)

(73) Assignee: Salesforce, Inc., San Francisco, CA (US)

(21) Appl. No.: 18/101,466

(22) Filed: Jan. 25, 2023

(51) Int. Cl. G06F 8/61; G06F 9/445

(52) U.S. Cl. CPC G06F 8/61; G06F 9/44505

(57) ABSTRACT

Methods, systems, and storage media are described for software installation configuration. In particular, some implementations are directed to configuring software instances by identifying and executing select software processes using parameters generated based on configuration information from a user. Other implementations may be disclosed or claimed.

### TECHNICAL FIELD

Some implementations disclosed herein are directed to software installation configuration. In particular, some implementations are directed to configuring software instances by identifying and executing select software processes using parameters generated based on configuration information from a user.

### BACKGROUND

Complex software installations are increasingly used in various applications. Such applications include, for example, cloud-based customer relationship management (CRM) platforms. However, for many complex software installations, setting up a new feature can take an administrator an extended period of time (e.g., anywhere from 5 minutes to 24 hours or longer). This process is also prone to human error, in which case the administrator has to retrace their own steps to identify the source of errors. Implementations of the present disclosure address these and other issues.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates an example of a block diagram showing a high-level functional architecture for software instance configuration in accordance with various implementations.

FIG. 2 illustrates an example of a flow diagram of a process for software instance configuration in accordance with various implementations.

FIG. 3 illustrates an example of a block diagram showing an example of a metadata-driven architecture in accordance with various implementations.

FIG. 4A illustrates an example of a configuration definition in accordance with various implementations.

FIG. 4B illustrates an example of some possible provisioning validation results in accordance with various implementations.

FIG. 4C illustrates an example of provisioning record values in accordance with various implementations.

FIG. 4D illustrates an example of two possible implementations for servicing provisioning tasks in accordance with various implementations.

FIG. 4E illustrates an example of an implementation utilizing tasks from a software tools suite in accordance with various implementations.

FIG. 4F illustrates an example of supporting provisioning configurations in accordance with various implementations.

FIG. 4G illustrates an example of a flow diagram for a process to configure a software instance in accordance with various implementations.

FIGS. 5A-5G illustrate data fields associated with an example of software instance configuration in accordance with various implementations.

FIG. 6 illustrates an example of a flow diagram of a process for configuring a software installation in accordance with various implementations.

FIG. 7A is a block diagram illustrating an electronic device in accordance with various implementations.

FIG. 7B is a block diagram of a deployment environment in accordance with various implementations.

### DETAILED DESCRIPTION

As introduced above, conventional systems to configure a complex software installation can take an administrator an extended period of time, and the configuration process is prone to incomplete/incorrect configurations as well as human error. Some previous solutions to address this issue including writing custom scripts to help users/customers set up their Salesforce Instance based on their particular needs, which is also time consuming and resource intensive.

As described in more detail below, implementations of the present disclosure address these and other issues by utilizing a Curated Experience Framework (CEF) that supports both runtime and predefined execution to configure software instances based on high-level configuration information provided by the user (e.g., via a questionnaire). The system identifies appropriate processes, and generates the necessary process parameters, based on the input from the user to automatically configure the software instance.

Implementations of the present disclosure may provide a number of advantages over prior systems for software instance configuration. For example, in some conventional systems a user (e.g., system administrator) is responsible for configuring the installation to match the user's particular use case requirements. Among other things, this requires enabling the necessary features, adding fields to layouts, adding components to pages, granting features and access to various users, and other procedures.

By utilizing a CEF-based system in accordance with the implementations disclosed herein, however, the system configures the software instance on the fly based on configuration information provided by the user (e.g., in response to questionnaires). For example, if the responses by the user in the questionnaires points to a service-orientated need, the system can present the user with the ideal service configuration and training documentation for the service-oriented need, thereby reducing or eliminating the need for manual configuration of the software by the user.

The CEF-based systems disclosed herein also provide a number of enhanced features over conventional software-configuration systems. For example, some implementations may allow users to enable various features without switching context. Additionally, the CEF systems disclosed herein can quickly and accurately identify dependencies among processes and variables involved in the software installation configuration. For example, in some implementations the system will wait for the required enablement steps to complete before executing a requested user action.

The implementations of the present disclosure can provide a cloud based solution to tailor an entire experience CRM/Cloud experience on demand at runtime. Some implementations provide multiple levels uniqueness check to ensure logically identical operations are performed once. Uniqueness identifiers may be checked/refreshed on each reboot. Some implementations may execute only new and applicable items during an upgrade, while items that are not modified from previous version are skipped. Some implementations may execute processes in a tree-like fashion, as well as in a synchronous or asynchronous manner.

As used herein, the term “curated experience” refers to a tailored configuration, steps, or onboarding guide that helps enhance a user's time to value based on the user's specific interests and use cases for a software instance. The term “provisioning configuration” refers to a collection of information to create a curated experience. This may include tasks, a data definition, and other suitable information. The term “plan” may be used to refer to a group of jobs to deliver an experience, while the term “job” may be used to refer to a group of tasks for a specific purpose, and the term “task” used to refer to an action to perform (e.g., such as Enable Org Preferences, Create Data, etc.).

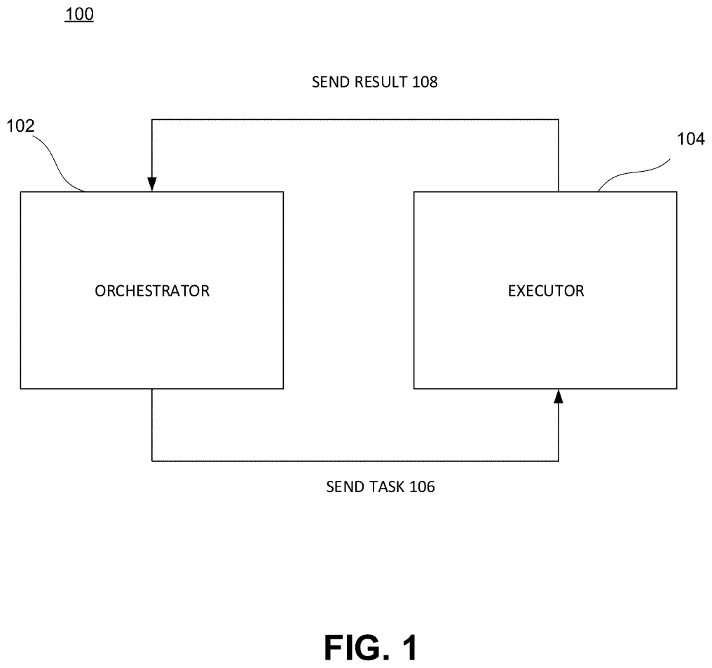

FIG. 1 illustrates an example of a block diagram showing a high-level functional architecture for software instance configuration in accordance with various implementations. In this example, system 100 includes an orchestrator component 102 and an executor component 104. The orchestrator 102 sends tasks 106 to the executor 104 to be executed, and the executor sends results 108 of the executed tasks back to the orchestrator 102.

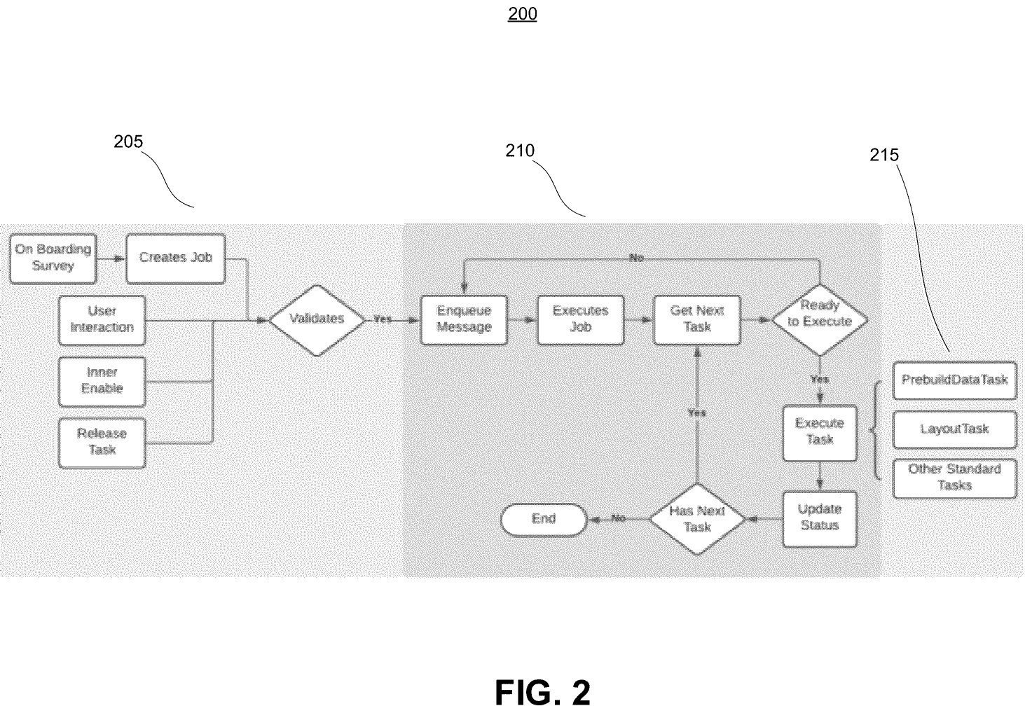

FIG. 2 illustrates an example of a flow diagram of a process for software instance configuration in accordance with various implementations. In this example, process 200 includes, in section 205, the creation and validation of a job based on an on-boarding survey (e.g., questionnaire) that provides configuration information specific to a user's software installation. In section 210, the system queues and executes the tasks associated with the job created in section 205. Section 215 provides three examples of tasks that may be executed (a prebuild data task, a layout task, and other standard tasks).

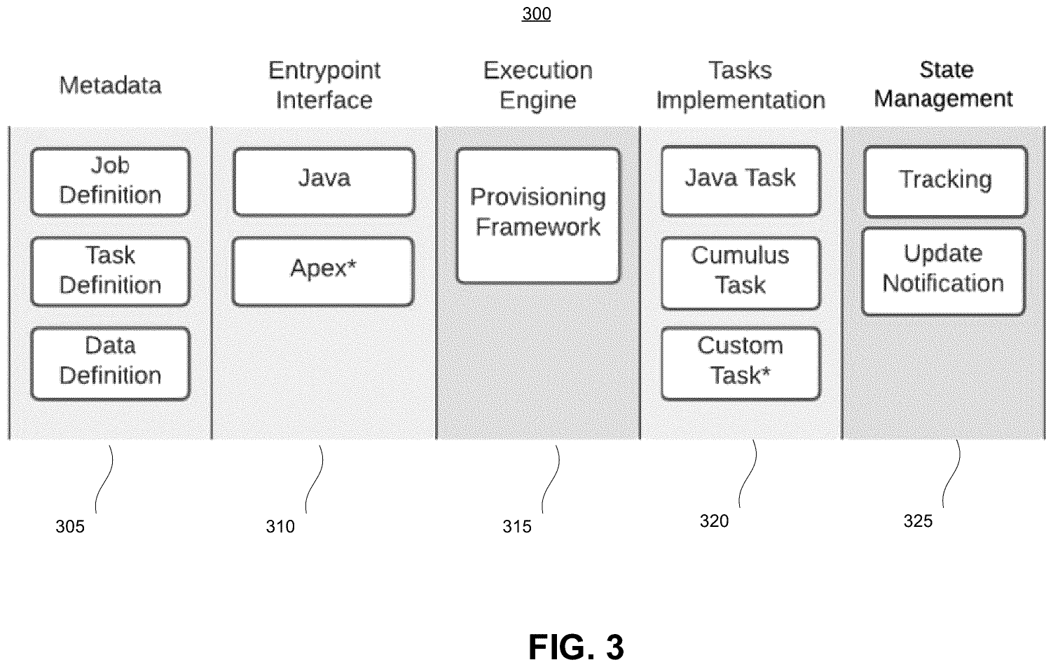

FIG. 3 illustrates an example of a block diagram showing an example of a metadata-driven architecture in accordance with various implementations. In this example, architecture 300 includes metadata 305 comprising a job definition, task definition, and data definition. The entry point interface 310 may include support for any suitable programming language, such as an object-oriented programming language like Java or Apex as illustrated. The execution engine 315 executes various tasks, and comprises a provisioning framework to provision the various tasks in the task implementation 320. The state management component 325 tracks the status of tasks being executed by the execution engine, and includes an update notification component to provide alerts when a task's status changes (e.g., from in progress to completed).

In section 305, the data definition may include a collection of files (e.g., in JavaScript Object Notation—JSON) for the system to use for creating end user data. The data definition may include code in the core module where metadata is stored to register the provisioning configuration, such as:

```
@Bean
public ProvisioningConfigurationProvider hvsProvider ( ) {
  return new ProvisioningConfigurationProvider ( ) {
    @Override
    public String getConfigurationDirectory ( ) {
      return ...
    }
  };
}
```

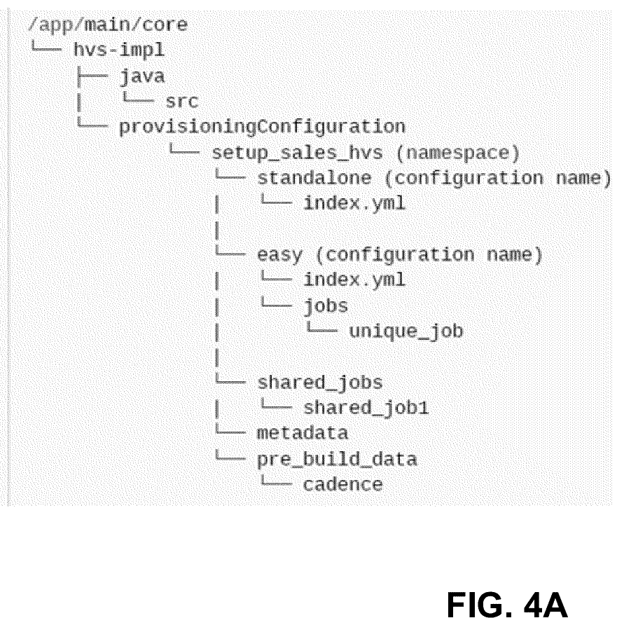

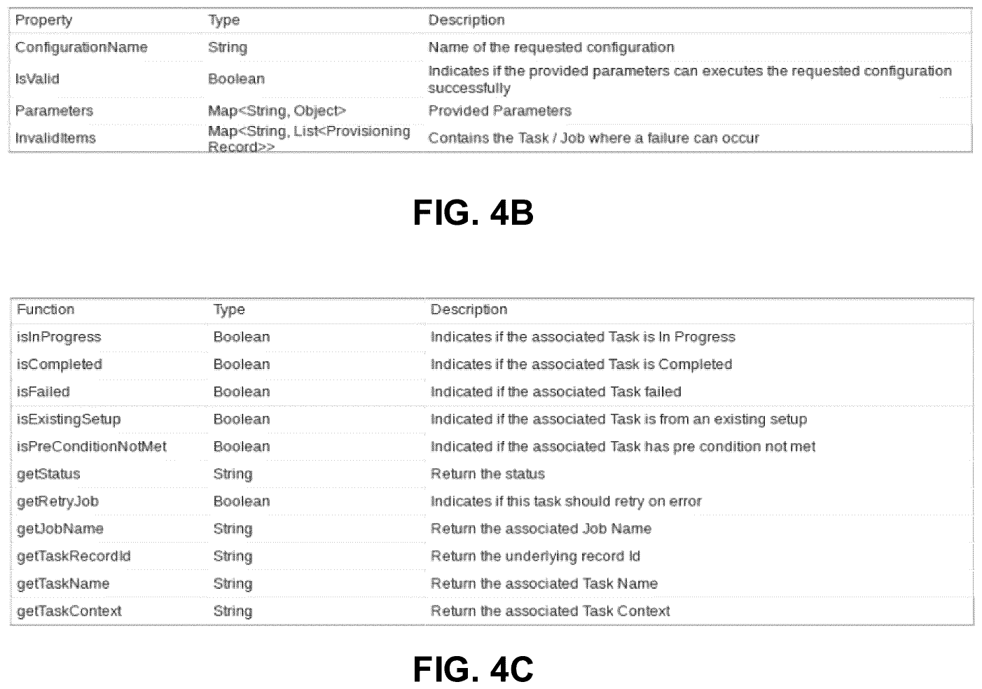

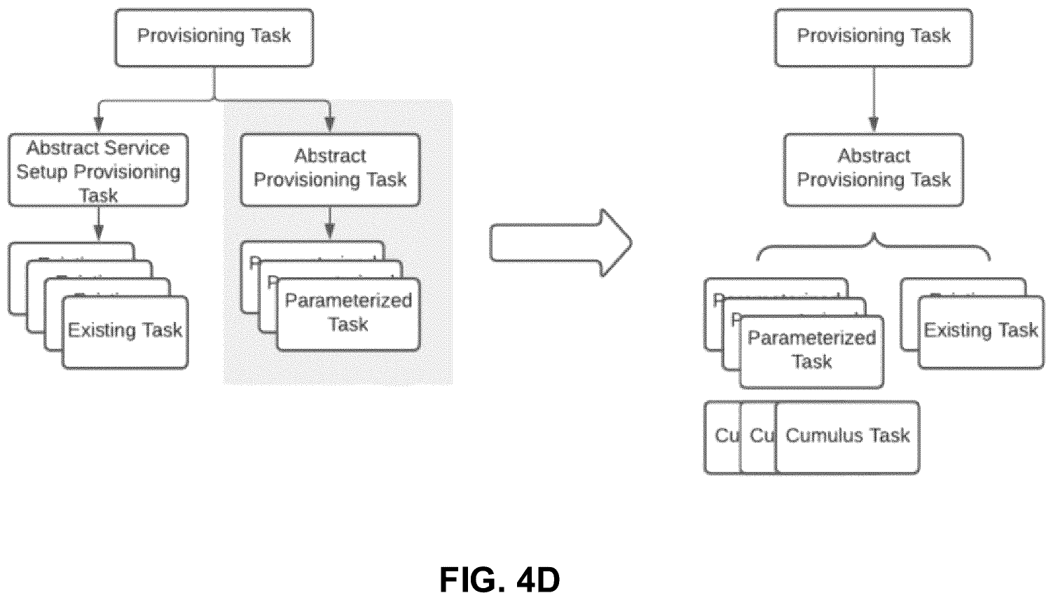

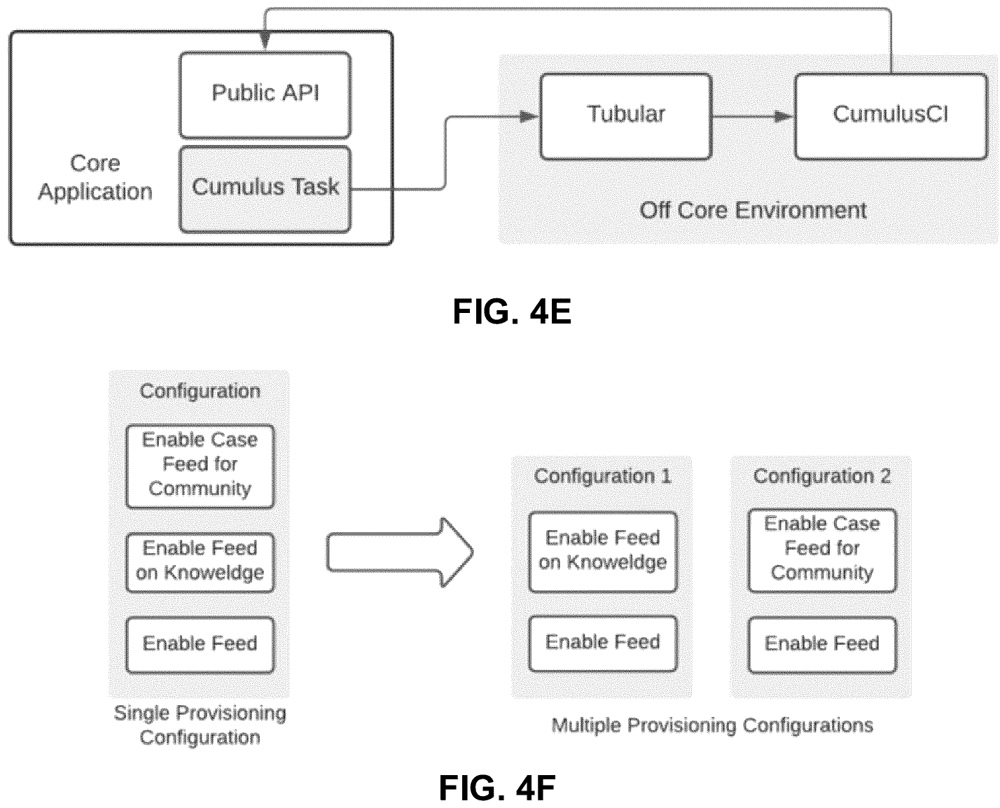

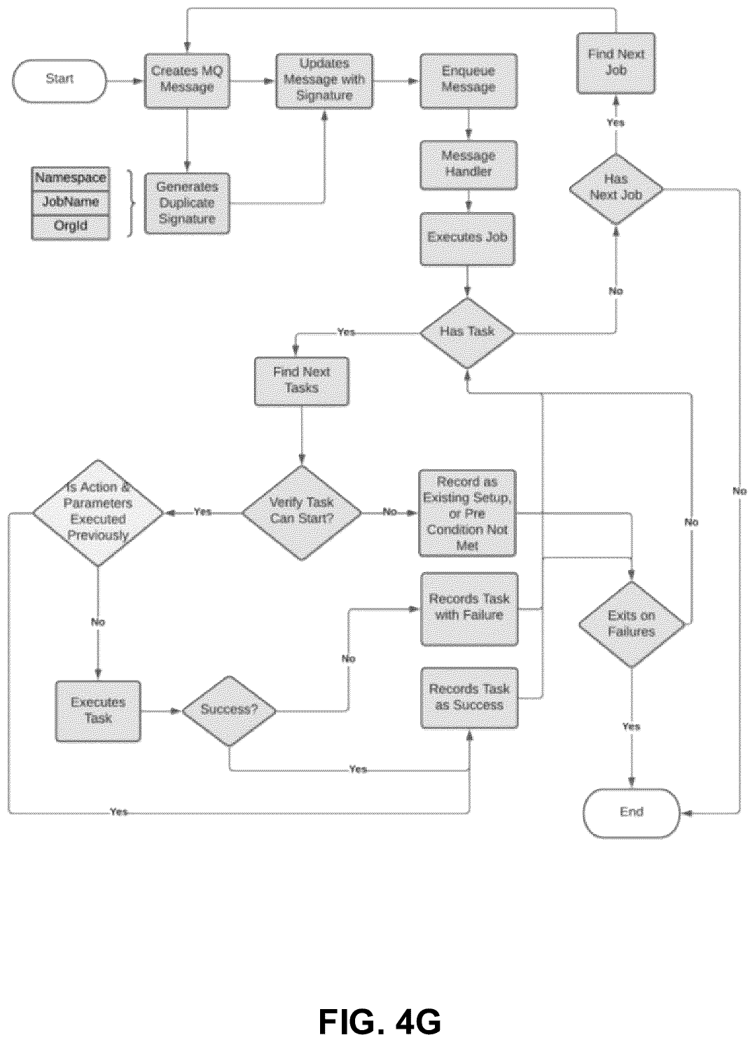

The metadata may include a configuration definition (not shown in FIG. 3) that can leverage file systems to determine a namespace or name. The system may use a file (e.g., index.yml) to identify the jobs to execute. FIG. 4A illustrates an example of a configuration definition in accordance with various implementations.

The job definition in section 305 may include a collection of tasks intended to provide a specific experience or setup configuration for the user. For example, an “UpdateDomain” job may include one or more tasks designed to update or create website domain information. The task definition in section 305 describes the action(s) performed by a particular task. In some implementations, the actions performed by a task may be applicable to multiple jobs, allowing jobs to be created/defined using low-level (detailed) generic functionality provided from executing a set of tasks.

In some implementations, the definitions in section 305 may be required to adhere to one or more requirements specific to a user's software installation. For example, one such requirement may be that data creation in the data definition respects as user's preferred locale and languages. To adhere to this requirement, the system may analyze a translated label, a portion of an example of which is shown below (indicating all languages allowed):

<section name =“CadencePreBuiltData” all_languages=“yes”>
<param name=“OutBound14DaysName”>...</param>
<param name=“OutBound14DaysDescription”>...</param>
</section>

In some implementations, the system may utilize a composite application programming interface (API) in conjunction with the entry point interface 310. An example of “GET” and “POST” features of such an API are shown below:

```
{
  “allOrNone” : true,
  “compositeRequest” : [
  {
    “method” : “GET”,
    “url” : “/services/data/v54.0/query?q=select Id from Folder where DeveloperNam
“referenceId” : “Folder”
  },
  {
    “method” : “POST”,
    “url” : “/services/data/v54.0/sobjects/ActionCadence”,
    “referenceId” : “Cadence”,
    “body” : {
    “Name” : “$LABEL.Cadence.OutBound14DaysName”,
    “Description” : “$LABEL.Cadence.OutBound14DaysDescription”,
    “FolderId” : “@{Folder.records[0].Id}”
  }
```

The entry point interface 310 may provide various functionality, such validating that a requested configuration name can be executed successfully with a given set of parameters, as well as executing the requested configuration name and checking the status of a provisioning configuration. FIG. 4B illustrates an example of some possible provisioning validation results in accordance with various implementations. FIG. 4C illustrates an example of provisioning record values in accordance with various implementations.

FIG. 4D illustrates an example of two possible implementations for servicing provisioning tasks in accordance with various implementations. In these examples, a parallel flow with a set of parameterized tasks is provided to operate concurrently with existing tasks. These parallel flows can process conventional “abstract service setup provisioning tasks” (which operate with the “existing tasks”) and updated “abstract provisioning tasks” in accordance with the CEF features described herein (which operate with the “parameterized tasks”).

Implementations of the present disclosure may operate in conjunction jobs or tasks from any suitable software libraries. For example, FIG. 4E illustrates an example of an implementation utilizing tasks from a software tools suite in accordance with various implementations. In this example, the system interfaces with a suite of tools called “CumulusCI” to access tasks provided by the suite. This implementation provides a number of advantageous features, including allowing: provisioning configuration (e.g., through Git/Git.Soma) to allow more frequent deployment, provisioning public cloud infrastructure (e.g., marketing cloud, commerce cloud, and others), and the creation of custom provisioning configurations and custom tasks.

As noted above, implementations of the present disclosure may provide a variety of different tasks for use with different jobs. Examples of some parameterized tasks include tasks to: enable organization preference; create end user facing data; updates details, search, or compact layout for entities; update customizable pages for entities; enable communities; deploy a set of metadata to an organization; assign permission sets to users; or update path and celebration moments for entities.

FIG. 4F illustrates an example of supporting provisioning configurations in accordance with various implementations. For example, conventional systems may be designed to provide only a single provisioning configuration (the left configuration), while implementations of the present disclosure may support multiple provisioning configurations (the right configuration). In some single-provisioning configurations, for example: task names are unique within each job, tasks are not shared between jobs, job names are unique in the system, rollback for selected tasks is allowed, and tasks are idempotent. In multiple-provisioning configurations of the present disclosure, by contrast, task names are unique within each job and tasks are idempotent (as with the single-provisioning configurations, but the following are new/different: rollback for selected tasks is allowed if not shared, namespace and job name combination is unique in the system, action & parameters combination is unique in the system, multiple configurations are executed in parallel, and a configuration can depend on another configuration.

Implementations of the present disclosure may store data associated with the configuration of a software installation in the fields of one or more database records. For example, a service setup provisioning record may include fields such as: ConfigurationName, Namespace, JobName, TaskName, Action, Status, Parameters, and TaskContext.

FIG. 4G illustrates an example of a flow diagram for a process to configure a software instance in accordance with various implementations. In this example, the system creates and enqueues messages associated with various jobs. The messages include an indication of a namespace, job name, and organization identifier as shown. The tasks associated with the jobs are identified and executed, with successful and failed tasks being recorded. In this example, the system determines whether an action or parameter has been executed previously in determining whether to execute the task or skip execution and proceed to the “records task as success” step.

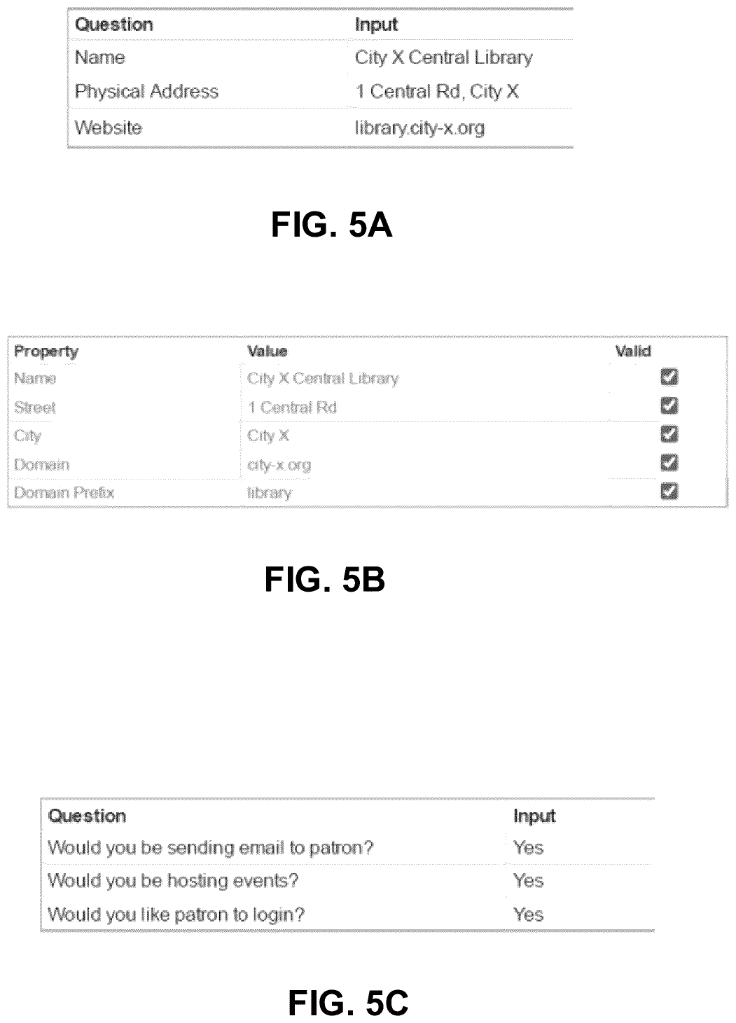

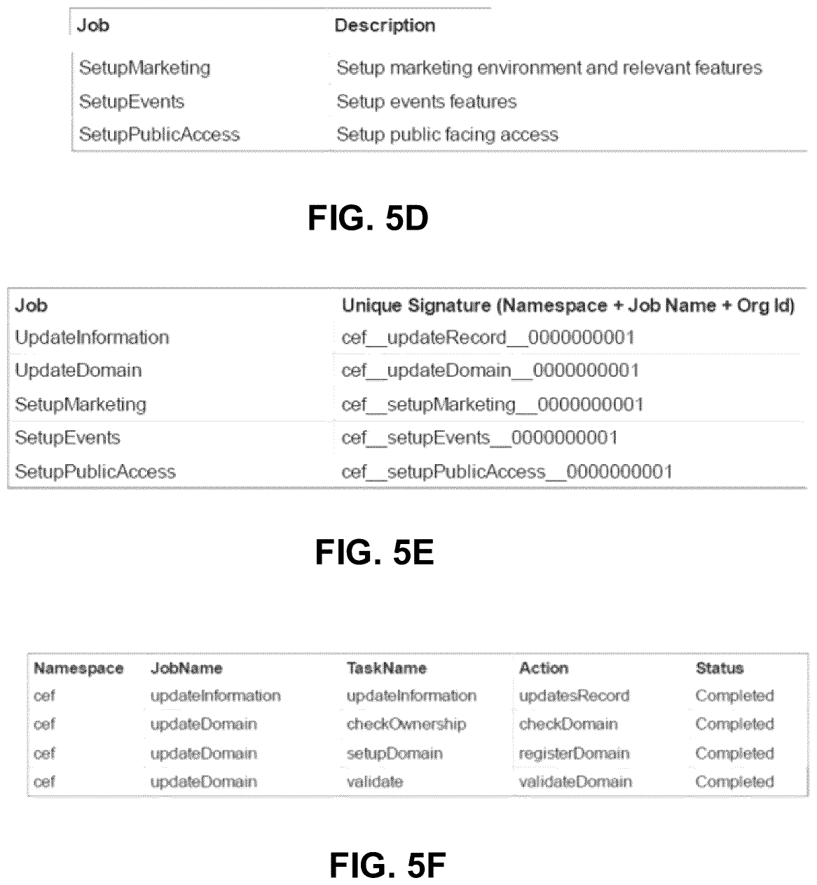

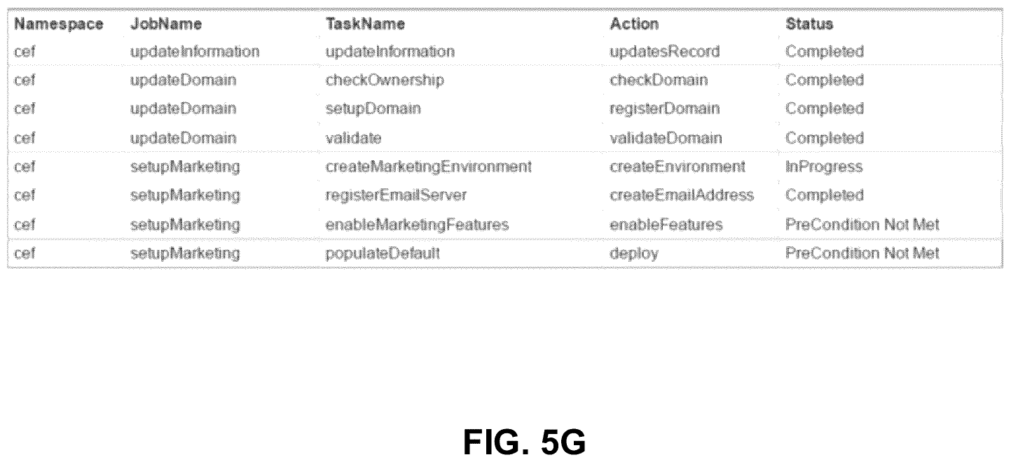

FIGS. 5A-5G illustrate data fields associated with an example of software instance configuration in accordance with various implementations. In this example, consider that City X is interested in changing their entire records system. This change will involve changes to their library system, property registration system, birth records, building and zoning permits; and other records.

A Curated Experience Framework (CEF) system in accordance with the implementations described herein may receive configuration information from an administrator for City X (e.g., in response to a questionnaire) as shown in FIG. 5A. Based on the configuration information received in FIG. 5A, the system validates the configuration information, identifies relevant jobs based on the configuration information, generates parameters usable by the identified jobs based on the configuration information, and submits a request to execute the jobs to the queue.

In this example, the system identified two jobs, “UpdateInformation,” and “UpdateDomain.” A list of parameters generated from the configuration information to be used by these two jobs is shown in FIG. 5B. In some implementations, the system may provide a user/administrator with multiple rounds of questionnaires to obtain configuration information based on the user's previous responses. In this example, after identifying the “UpdateInformation” and “UpdateDomain” jobs to be performed, the system generates a second questionnaire and provides it to the computing device of the user via electronic communication. The second questionnaire includes three questions as shown in FIG. 5C, which the user submits to the system (from the user's computing device back to the system via electronic communication).

The system analyzes the second questionnaire and identifies three additional jobs to be performed, as shown in FIG. 5D. The job queue is shown in FIG. 5E after all five jobs have been submitted for execution. For each job in the queue, the system determines whether execution of the job is dependent on prior execution of any other job. In this example, the system first finds the UpdateInformation job in the queue. Since there is no dependency, the system executes it immediately. The system next finds the UpdateDomain job in the queue, and determines it has a dependency on cef_updateInformation. In this case, cef_updateInformation has a “completed” status, therefore the UpdateDomain job is executed. The state representation of the job queue after execution of these first two jobs is shown in FIG. 5F.

As the system continues to execute the jobs in the queue, it finds the SetupMarketing job, and the first task (of four tasks) in this job is setupDomain, which uses a registerDomain action. The system finds a corresponding entry with Completed status, and (since the action has already been performed) skips it. The createEnvironment action is an action that creates a service using a cloud provider.

The state representation of the job queue after execution of SetupMarketing is shown in FIG. 5G. When cef_setupMarketing_createMarketingEnvironment completes, the system checks for its dependents. It finds cef_setupMarketing_enableMarketingFeatures and cef_setupMarketing_populateDefault with PreCondition Not Met, therefore the system enqueues cef_setupMarketing again to the execution queue.

As noted previously, the jobs, tasks and actions may be defined in metadata for usage by the system in accordance with various implementations. An example of metadata fields (unpopulated) for the “UpdateInformation” job is shown below:
name: updateInformation
description: Update information for an existing record
tasks:
   name: updateInformation
      action: updatesRecord
      options:
      name:
      street:
      city:

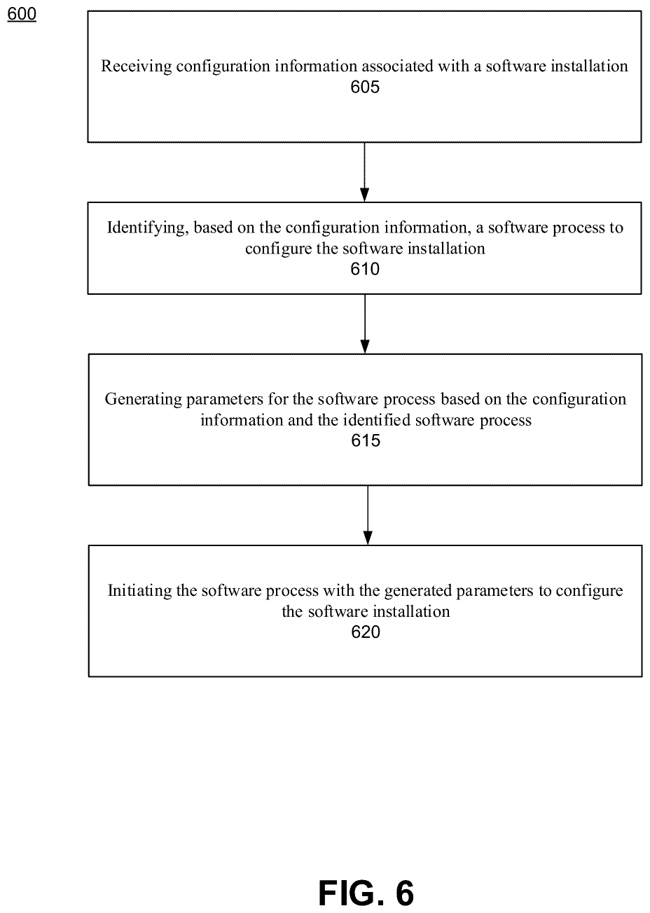

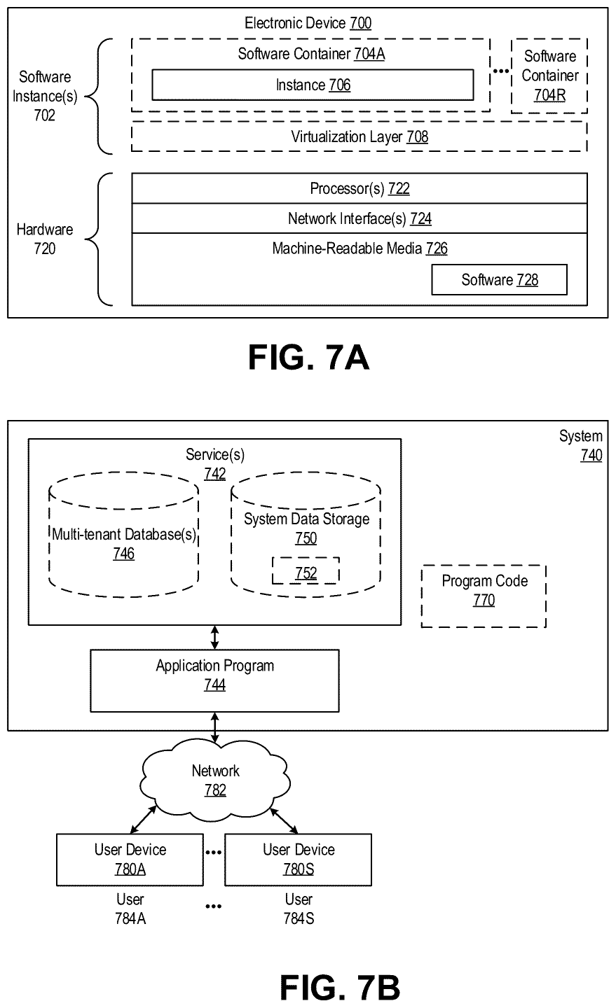

FIG. 6 illustrates a flow diagram for an example of a process in accordance with various implementations. Implementations of the present disclosure may implement more or fewer steps than illustrated in FIG. 6. Implementations of the present disclosure may implement the process shown in FIG. 6 (and other processes described herein) using any suitable combinations of systems and devices, including the systems illustrated in FIGS. 7A and 7B.

In the example depicted in FIG. 6, process 600 includes, at 605, receiving configuration information associated with a software installation, such as the configuration information illustrated in FIG. 5A. The process further includes, at 610, identifying, based on the configuration information, a software process to configure the software installation, such as the jobs illustrated in FIG. 5E-5G. Process 200 further includes, at 615, generating parameters for the software process based on the configuration information and the identified software process, such as the parameters shown in FIG. 5B. The process further includes, at 620, initiating the software process with the generated parameters to configure the software installation.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### Electronic Devices and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and machine-readable media 726 having stored therein software 728 (which includes instructions executable by the set of one or more processor(s) 722). The machine-readable media 726 may include non-transitory and/or transitory machine-readable media. Each of the previously described clients and the network protocol for extending a trust boundary between cloud domains of the same entity may be implemented in one or more electronic devices 700. In one implementation: 1) each of the clients is implemented in a separate one of the electronic devices 700 (e.g., in end user devices where the software 728 represents the software to implement clients to interface directly and/or indirectly with the network protocol for extending a trust boundary between cloud domains of the same entity (e.g., software 728 represents a web browser, a native client, a portal, a command-line interface, and/or an application programming interface (API) based upon protocols such as Simple Object Access Protocol (SOAP), Representational State Transfer (REST), etc.)); 2) the network protocol for extending a trust boundary between cloud domains of the same entity is implemented in a separate set of one or more of the electronic devices 700 (e.g., a set of one or more server devices where the software 728 represents the software to implement the network protocol for extending a trust boundary between cloud domains of the same entity); and 3) in operation, the electronic devices implementing the clients and the network protocol for extending a trust boundary between cloud domains of the same entity would be communicatively coupled (e.g., by a network) and would establish between them (or through one or more other layers and/or or other services) connections for submitting configuration data to the network protocol for extending a trust boundary between cloud domains of the same entity and returning a software package to the clients. Other configurations of electronic devices may be used in other implementations (e.g., an implementation in which the client and the network protocol for extending a trust boundary between cloud domains of the same entity are implemented on a single one of electronic device 700).

During operation, an instance of the software 728 (illustrated as instance 706 and referred to as a software instance; and in the more specific case of an application, as an application instance) is executed. In electronic devices that use compute virtualization, the set of one or more processor(s) 722 typically execute software to instantiate a virtualization layer 708 and one or more software container(s) 704A-704R (e.g., with operating system-level virtualization, the virtualization layer 708 may represent a container engine (such as Docker Engine by Docker, Inc. or rkt in Container Linux by Red Hat, Inc.) running on top of (or integrated into) an operating system, and it allows for the creation of multiple software containers 704A-704R (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers 704A-704R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 728 is executed within the software container 704A on the virtualization layer 708. In electronic devices where compute virtualization is not used, the instance 706 on top of a host operating system is executed on the “bare metal” electronic device 700. The instantiation of the instance 706, as well as the virtualization layer 708 and software containers 704A-704R if implemented, are collectively referred to as software instance(s) 702.

Alternative implementations of an electronic device may have numerous variations from that described above. For example, customized hardware and/or accelerators might also be used in an electronic device.

### Environment Example

FIG. 7B is a block diagram of a deployment environment according to some example implementations. A system 740 includes hardware (e.g., a set of one or more server devices) and software to provide service(s) 742, including services associated with the implementations described herein. In some implementations the system 740 is in one or more datacenter(s). These datacenter(s) may be: 1) first party datacenter(s), which are datacenter(s) owned and/or operated by the same entity that provides and/or operates some or all of the software that provides the service(s) 742; and/or 2) third-party datacenter(s), which are datacenter(s) owned and/or operated by one or more different entities than the entity that provides the service(s) 742 (e.g., the different entities may host some or all of the software provided and/or operated by the entity that provides the service(s) 742). For example, third-party datacenters may be owned and/or operated by entities providing public cloud services (e.g., Amazon.com, Inc. (Amazon Web Services), Google LLC (Google Cloud Platform (GCP)), Microsoft Corporation (Azure)).

The system 740 is coupled to user devices 780A-780S over a network 782. The service(s) 742 may be on-demand services that are made available to one or more of the users 784A-784S working for one or more entities other than the entity which owns and/or operates the on-demand services (those users sometimes referred to as outside users) so that those entities need not be concerned with building and/or maintaining a system, but instead may make use of the service(s) 742 when needed (e.g., when needed by the users 784A-784S). The service(s) 742 may communicate with each other and/or with one or more of the user devices 780A-780S via one or more APIs (e.g., a REST API). In some implementations, the user devices 780A-780S are operated by users 784A-784S, and each may be operated as a client device and/or a server device. In some implementations, one or more of the user devices 780A-780S are separate ones of the electronic device 700 or include one or more features of the electronic device 700.

In some implementations, the system 740 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 740 is a multi-tenant cloud computing architecture supporting multiple services, such as one or more of the following types of services: Self-Healing Build Pipeline service 742; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 740 may include an application platform 744 that enables PAAS for creating, managing, and executing one or more applications developed by the provider of the application platform 744, users accessing the system 740 via one or more of user devices 780A-780S, or third-party application developers accessing the system 740 via one or more of user devices 780A-780S.

In some implementations, one or more of the service(s) 742 may use one or more multi-tenant databases 746, as well as system data storage 750 for system data 752 accessible to system 740. In certain implementations, the system 740 includes a set of one or more servers that are running on server electronic devices and that are configured to handle requests for any authorized user associated with any tenant (there is no server affinity for a user and/or tenant to a specific server). The user devices 780A-780S communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the multi-tenant database(s) 746 and/or system data storage 750.

In some implementations, the service(s) 742 are implemented using virtual applications dynamically created at run time responsive to queries from the user devices 780A-780S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the network protocol for extending a trust boundary between cloud domains of the same entity, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 740 and the user devices 780A-780S.

Each user device 780A-780S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 740. For example, the user interface device can be used to access data and applications hosted by system 740, and to perform searches on stored data, and otherwise allow one or more of users 784A-784S to interact with various GUI pages that may be presented to the one or more of users 784A-784S. User devices 780A-780S might communicate with system 740 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 780A-780S might include an HTTP client, commonly referred to as a “browser,” for sending and receiving HTTP messages to and from server(s) of system 740, thus allowing users 784A-784S of the user devices 780A-780S to access, process and view information, pages and applications available to it from system 740 over network 782.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer system comprising:
a processor; and
memory coupled to the processor and storing instructions that, when executed by the processor, are configurable to cause the computer system to:
receive configuration information associated with a software installation;
identify, based on the configuration information, a software process to configure the software installation;
generate parameters for the software process based on the configuration information and the identified software process; and
initiate the software process with the generated parameters to configure the software installation.

2. The computer system of claim 1, wherein to receive the configuration information associated with the software installation is to:
send a first electronic communication to a computing device of a user including one or more questions prompting the user for the configuration information; and
receive a second electronic communication from the computing device of the user that includes the configuration information in responses to the one or more questions.

3. The computer system of claim 1, wherein each generated parameter for the software process includes a subset of the received configuration information.

4. The computer system of claim 1, wherein the memory stores instructions to cause the computer system to:
identify a plurality of software processes to configure the software installation based on the configuration information;
generate a respective set of parameters for each respective software process in a plurality of software processes; and
initiate each respective software process with the respective generated parameters to configure the software installation.

5. The computer system of claim 4, wherein to initiate each respective software process is to identify whether any dependencies exist among the plurality of software processes.

6. The computer system of claim 5, wherein to initiate each respective software process is to order execution of the plurality software processes based on at least one identified dependency.

7. The computer system of claim 1, wherein the software process has a unique identifier comprising a name space, job name, and organization identifier.

8. The computer system of claim 1, wherein the software process includes a plurality of tasks, and each respective task in the plurality of tasks has a respective status.

9. The computer system of claim 8, wherein to initiate the software process is to execute each uncompleted task in the plurality of tasks, and to skip each previously-completed task in the plurality of tasks.

10. The computer system of claim 9, wherein to execute each uncompleted task is to wait to execute a first task while a second task is in progress or not yet initiated.

11. The computer system of claim 10, wherein the first task is dependent upon completion of one or more actions by the second task.

12. The computer system of claim 8, wherein to initiate the software process is to re-execute at least one task in response to a determination that at least one precondition associated with the at least one task is not met.

13. The computer system of claim 1, wherein the software process is to create a database record associated with the software installation, or to update information for an existing record associated with the software installation.

14. The computer system of claim 1, wherein the software process is to create or update domain information associated with the software installation.

15. The computer system of claim 14, wherein the software process includes a task to check ownership of a domain, a task to register the domain, and a task to validate the domain.

16. The computer system of claim 1, wherein the software process is to set up an environment associated with the software installation, and wherein the software process includes: a task to register a domain, a task to register a server, and a task to enable features associated with the software process.

17. The computer system of claim 1, wherein the software process is to set up an event associated with the software installation, and wherein the software process includes: a task to register a domain, a task to create a calendar, a task to connect an event to the calendar, and a task to publish the calendar.

18. The computer system of claim 1, wherein the software process is to set up access to the software installation, and wherein the software process includes: a task to register a domain, a task to create an environment, and a task to deploy the environment.

19. A tangible, non-transitory computer-readable medium storing instructions that, when executed by a computer system, are configurable to cause the computer system to:
receive configuration information associated with a software installation;
identify, based on the configuration information, a software process to configure the software installation;
generate parameters for the software process based on the configuration information and the identified software process; and
initiate the software process with the generated parameters to configure the software installation.

20. A method comprising:
receiving, by a computer system, configuration information associated with a software installation;
identifying, by the computer system based on the configuration information, a software process to configure the software installation;
generating, by the computer system, parameters for the software process based on the configuration information and the identified software process; and
initiating, by the computer system, the software process with the generated parameters to configure the software installation.
